(19) United States
(12) Patent Application Publication
(10) Pub. No.: US 2016/0040640 A1
(43) Pub. Date: Feb. 11, 2016

(54) FLUID INJECTION DEVICE

(71) Applicant: Engineering Center Steyr GmbH & Co KG, St. Valentin (AT)

(72) Inventors: Christian FREINHOFER, Kronsdorf (AT); Friedrich KRÖPL, Kronsdorf (AT); Norbert SCHÖFBÄNKER, Ohlsdorf (AT)

(21) Appl. No.: 14/817,256

(22) Filed: Aug. 4, 2015

(30) Foreign Application Priority Data
Aug. 5, 2014 (DE) 10 2014 215 450.2

(51) Int. Cl. F02M 61/10; F02M 63/00

(52) U.S. Cl. CPC F02M 61/10; F02M 63/0021

(57) ABSTRACT

A fluid injection device for a combustion engine comprising a nozzle body, a first nozzle needle being arranged inside the nozzle body and configured as a hollow needle, and a second nozzle needle being arranged inside the first nozzle needle, wherein the first nozzle needle and the second nozzle needle are axially displaceable. The second nozzle needle constitutes the valve needle of a solenoid valve, and the second nozzle needle is configured as an at least partially pressure-compensated nozzle needle so that an axial movement of the second nozzle needle can be controlled by the solenoid valve without hydraulic transmission.

### CROSS-REFERENCE TO RELATED APPLICATIONS

This application claims the benefit and priority of German Application No. DE 10 2014 215 450.2 filed Aug. 5, 2014. The entire disclosure of the above application is incorporated herein by reference.

### TECHNICAL FIELD

The present disclosure relates to a fluid injection device for a combustion engine.

### BACKGROUND

This section provides background information related to the present disclosure which is not necessarily prior art.

The fuel necessary for internal combustion is fed to combustion engines via injection devices of every type. Here the fuel is brought to system pressure by a pump and fed to the injection device.

An injection device generally comprises a nozzle body and a nozzle needle, injection apertures, through which the fuel can be injected into the combustion chamber of the combustion engine, being provided in the nozzle body. The injection apertures are opened or closed by a lifting movement of the nozzle needle. As a rule, the nozzle needle movement (lifting movement) is controlled by a fall in pressure and/or rise in pressure inside one or more control chambers.

In a combustion engine, the rate of injection of the fuel injection quantity (injection curve profile) has a substantial influence on the fuel combustion sequence and therefore on the fuel consumption and the pollutant emissions. Depending on the operating state (partial load range or full load range) of the combustion engine, it is therefore essential that modern injection devices afford the facility for shaping the injection curve profile—an ideal injection device allows free scope for selecting the injection curve profile with various timing patterns. Thus in the partial load range of the combustion engine, for example, an injection device having a reduced flow rate is desirable, in order to dispense the fuel injection quantity over a longer period of time and at the highest possible pressure (improved atomization).

The problem encountered in the general state of the art is one of shaping the injection curve profile by way of an injection device having two nozzle needles, which open or close two series of injection apertures with different rates of flow. In this case actuating the two nozzle needles separately without incurring any great design outlay represents a challenge.

DE 102 05 970 A1, for example, describes a so-called variable nozzle—the fuel injector comprises two series of injection nozzle holes, to which an inner and a coaxially outer nozzle needle are assigned. The nozzle needles can be actuated as a function of the pressure to open different injection cross sections. The outer and the inner nozzle needle each have a control piston assigned to them, which in each case act upon a hydraulic chamber filled with fuel, so that the hydraulic chambers function as actively actuated control chambers. The two control chambers are connected to one another by a connecting duct. The control chamber of the outer nozzle needle can be connected via an outlet restrictor to a low-pressure return system. The connecting duct is designed so that when the outlet restrictor opens the pressure first falls in the control chamber of the outer nozzle needle and the pressure in the control chamber of the inner nozzle needle falls after a time delay. A flexible actuation of the inner and the outer nozzle needle independently of one another is not possible in this way.

DE 10 2004 038 189 A1, for example, describes a fuel injection device for a combustion engine having directly actuated nozzle needles. The fuel injector of the fuel injection device comprises an inner nozzle needle and an outer nozzle needle arranged coaxially with the former, a nozzle needle being assigned to each series of injection nozzle holes and the inner and outer nozzle needle opening or closing the injection nozzles. A control chamber and a damping piston are assigned to the outer nozzle needle, and a further control chamber to the inner nozzle needle. Separate switching valves are provided for actuating each of the outer and inner nozzle needles. This allows a flexible actuation of both nozzle needles for a simpler design outlay taking up little overall space.

### SUMMARY

This section provides a general summary of the disclosure and is not intended to be considered a comprehensive disclosure of its full scope or all of its objects and features.

The object of the present disclosure is to propose an alternative embodiment of a fluid injection device, which allows a flexible control of two nozzle needles independently of one another.

The object is achieved by a fluid injection device for a combustion engine comprising a nozzle body, a first nozzle needle being arranged inside the nozzle body, the first nozzle needle being designed as a hollow needle, at least a second nozzle needle being arranged inside the first nozzle needle, the first nozzle needle and the second nozzle needle being axially displaceable, the second nozzle needle constituting the valve needle of a solenoid valve, the second nozzle needle being designed as an at least partially pressure-compensated nozzle needle, so that an axial movement of the second nozzle needle can be controlled by the solenoid valve without hydraulic transmission.

According to the present disclosure, the fluid injection device comprises a nozzle body, at least a first nozzle needle being arranged inside the nozzle body. The first nozzle needle is designed as a hollow needle. A second nozzle needle is arranged coaxially inside the first nozzle needle. Both nozzle needles can perform an axial movement.

According to the present disclosure, the second nozzle needle constitutes the valve needle of a solenoid valve and is designed as a pressure-compensated or at least partially pressure-compensated nozzle needle. The axial movement of the second nozzle needle can therefore be controlled directly by the solenoid valve without hydraulic transmission.

The second nozzle needle is of pressure-compensated or at least partially pressure-compensated design. The advantage of such a nozzle needle is that a movement of the nozzle needle can be achieved by means of lower forces.

According to one embodiment of the present disclosure, the axial movement of the first nozzle needle is controlled by a rise in pressure and/or fall in pressure in a control chamber. Here the pressure inside the control chamber can preferably be adjusted by at least one inlet restrictor and at least one outlet restrictor.

According to the present disclosure, the first nozzle needle and the second nozzle needle can therefore be controlled separately from one another. In this way it is possible to achieve a fully flexible shaping of the injection curve profile.

A first series of injection holes is preferably opened or closed by the axial movement of the first nozzle needle and a second series of injection holes by the axial movement of the second nozzle needle. The facility for controlling the axial movement of the first nozzle needle and/or the second nozzle needle separately from one another allows the first series of injection holes and the second series of injection holes to be opened or closed independently of one another.

The second series of injection holes preferably has a smaller bore diameter than the first series of injection holes. Smaller fluid injection quantities can therefore be released via the second series of injection holes and larger fluid injection quantities can be released via the first series of injection holes.

The fluid injection device according to the invention, therefore combines the two functions of “flexible shaping of the injection curve profile” and “variable nozzle rate of flow”, the latter function, in particular, causing a significant improvement in the reduction of emissions in the partial load range of the combustion engine.

If both the first and the second series of injection holes are opened for fluid injection, on termination of the fluid injection the first series of injection holes is first closed by the first nozzle needle and thereafter the second series of injection holes is closed by the second nozzle needle with something of a time delay.

The first nozzle needle comprises a seat, preferably a conical seat, on the inside of the nozzle body. This affords a tight closure of the first series of injection holes.

The second nozzle needle likewise comprises a seat, preferably a slide seat or a conical seat, on the inside of the first nozzle needle. This affords a tight closure of the second series of injection holes.

In an advantageous design variant of the present invention an armature of a solenoid of the solenoid valve is mounted directly on to the second nozzle needle.

The armature of the solenoid of the solenoid valve is preferably designed as a flat armature, the armature being pressed on to the second nozzle needle, for example, or secured by positive interlock, or being designed as a plunger-type armature.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. The invention is explained in more detail below with reference to the exemplary embodiment represented in the drawings.

FIG. 1 shows a sectional view of the fluid injection device according to the invention; and

FIG. 2 shows a detailed sectional view of the fluid injection device according to the invention.

### DESCRIPTION

One or more example embodiments of a fluid injection device will now be more fully described with reference to the drawings. To this end, the example embodiments are provided so that this disclosure will be thorough, and will fully convey its intended scope to those who are skilled in the art. Accordingly, numerous specific details are set forth such as examples of specific components, devices, and methods, to provide a thorough understanding of embodiments of the present disclosure. However, it will be apparent to those skilled in the art that specific details need not be employed, that example embodiments may be embodied in many different forms, and that neither should be construed to limit the scope of the present disclosure. In some example embodiments, well-known processes, well-known device structures, and well-known technologies are not described in detail.

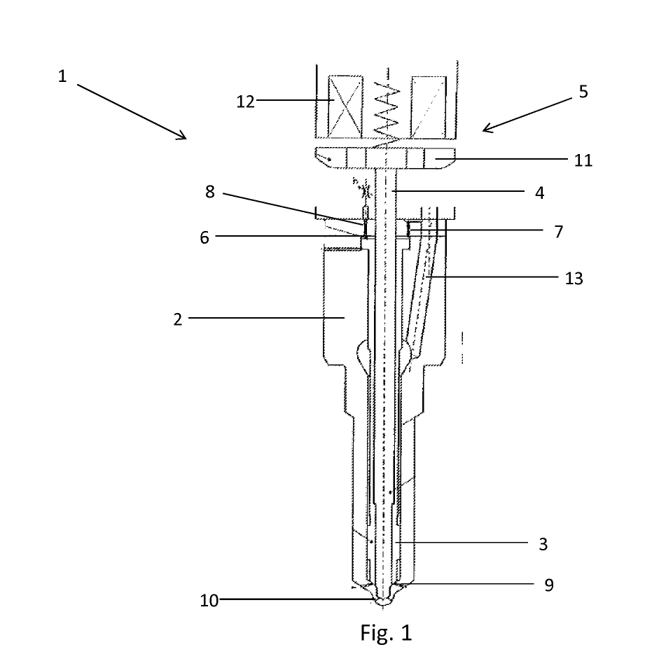

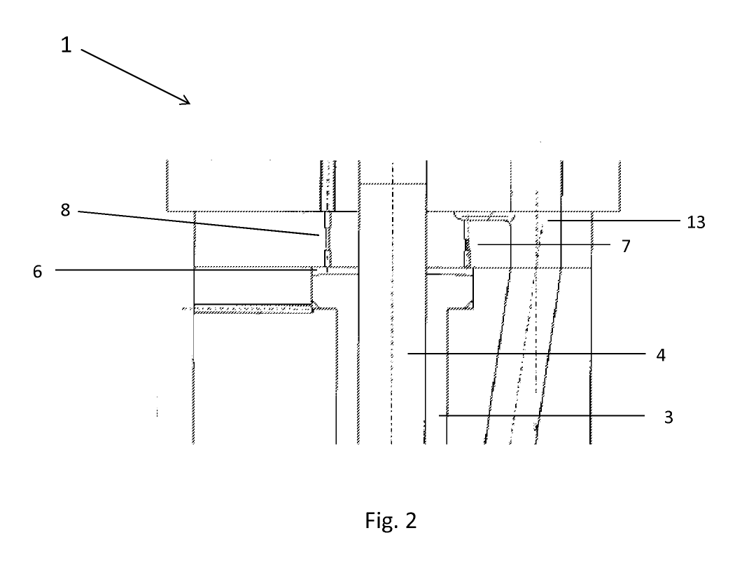

FIG. 1 represents a sectional view of a fluid injection device 1 according to the invention. FIG. 2 shows a detailed view of the sectional representation of the fluid injection device 1 according to the invention.

The fluid injection device 1 comprises a nozzle body 2. At least a first nozzle needle 3 is arranged inside the nozzle body 2. The first nozzle needle 3 is designed as a hollow needle and a second nozzle needle 4 is arranged coaxially inside the first nozzle needle 3.

The first nozzle needle 3 and the second nozzle needle 4 can perform an axial movement. The second nozzle needle 4 constitutes the valve needle of a solenoid valve 5 and is designed as an at least partially pressure-compensated nozzle needle. The axial movement of the second nozzle needle 4 can therefore be controlled directly by the solenoid valve 5 without hydraulic transmission.

The axial movement of the first nozzle needle 3 can be controlled by a rise in pressure and/or fall in pressure in a control chamber 6. Here the pressure inside the control chamber 6 can be adjusted by at least one inlet restrictor 7 and at least one outlet restrictor 8 (FIG. 2). Fluid at high pressure (system pressure) is fed to the control chamber 6 via the inlet restrictor 7 and fluid in a low-pressure range is discharged via the outlet restrictor 8. The outlet restrictor 8 can be controlled by a control valve.

The first nozzle needle 3 and the second nozzle needle 4 can therefore be controlled separately from one another.

A series of first injection holes 9 is opened or closed by the axial movement of the first nozzle needle 3. A series of second injection holes 10 is opened or closed by the axial movement of the second nozzle needle 4. The facility for separate control of the axial movement of the first nozzle needle 3 via the pressure in the control chamber 6 and/or the second nozzle needle 4 via the solenoid valve 5 allows the first injection holes 9 and the second injection holes 10 to be opened or closed independently of one another.

The second injection holes 10 have a smaller bore diameter than the first injection holes 9. Smaller fluid injection quantities can therefore be released via the second injection holes 10 and larger fluid injection quantities can be released via the first injection holes 9.

The first nozzle needle 3 comprises a seat, preferably a conical seat, on the inside of the nozzle body 2. This affords a tight closure of the first injection holes 9.

The second nozzle needle 4 likewise comprises a seat, preferably a slide seat or a conical seat, on the inside of the first nozzle needle 3. This affords a tight closure of the second injection holes 10.

An armature 11 of a solenoid 12 of the solenoid valve 5 is mounted directly on to the second nozzle needle 4.

In the sectional view represented in FIG. 1 the armature 11 of the solenoid 12 of the solenoid valve 5 is designed as a flat armature.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

### LIST OF REFERENCE SIGNS

1 fluid injection device

2 nozzle body

3 first nozzle needle

4 second nozzle needle

5 solenoid valve

6 control chamber

7 inlet restrictor

8 outlet restrictor

9 first series of injection holes

10 second series of injection holes

11 armature

12 solenoid

1. A fluid injection device for a combustion engine comprising a nozzle body, a first nozzle needle being arranged inside the nozzle body, the first nozzle needle being configured as a hollow needle, and a second nozzle needle being arranged inside the first nozzle needle, the first nozzle needle and the second nozzle needle being axially displaceable, wherein the second nozzle needle constitutes the valve needle of a solenoid valve, and wherein the second nozzle needle is configured as an at least partially pressure-compensated nozzle needle so that an axial movement of the second nozzle needle can be controlled by the solenoid valve without hydraulic transmission.

2. The fluid injection device according to claim 1, wherein the axial movement of the first nozzle needle is produced by a rise in pressure and/or fall in pressure in a control chamber, and wherein a pressure inside the control chamber being adjustable by at least one inlet restrictor and at least one outlet restrictor.

3. The fluid injection device according to claim 2, wherein the first nozzle needle and the second nozzle needle can be controlled separately from one another.

4. The fluid injection device according to claim 1, wherein the first nozzle needle controls a series of first injection holes and the second nozzle needle controls a series of second injection holes.

5. The fluid injection device according to claim 3, wherein the second injection holes have a smaller bore diameter than the first injection holes.

6. The fluid injection device according to claim 1, wherein the first nozzle needle comprises a conical seat.

7. The fluid injection device according to claim 1, wherein the second nozzle needle comprises a slide seat or a conical seat.

8. The fluid injection device according to claim 1, wherein an armature of a solenoid of the solenoid valve is mounted directly on to the second nozzle needle.

9. Fluid injection device according to claim 1, wherein the armature of the solenoid of the solenoid valve is designed as a flat armature or a plunger-type armature.
